(19) United States
(12) Patent Application Publication
(10) Pub. No.: US 2026/0018123 A1
(43) Pub. Date: Jan. 15, 2026

(54) ADAPTIVE VOLTAGE CONTROL CIRCUIT AND CONTROL METHOD THEREOF

(71) Applicant: SAMSUNG ELECTRONICS CO., LTD., SUWON-SI (KR)

(72) Inventors: Dongyeol LEE, Suwon-si (KR); Seung-Hoon BAEK, Suwon-si (KR); Juyong LEE, Suwon-si (KR); Choonghoon LEE, Suwon-si (KR)

(21) Appl. No.: 19/024,247

(22) Filed: Jan. 16, 2025

(30) Foreign Application Priority Data
Jul. 12, 2024 (KR) 10-2024-0092640

(51) Int. Cl. G09G 3/3233; G09G 3/32

(52) U.S. Cl. CPC G09G 3/3233; G09G 3/32; G09G 2300/0852; G09G 2330/021; G09G 2330/028

(57) ABSTRACT

An adaptive voltage control (AVC) circuit including: a voltage application circuit configured to apply a first voltage or a second voltage to a voltage output circuit, wherein the first voltage is generated by dividing a panel driving voltage; and the voltage output circuit configured to generate a third voltage based on the first or second voltage and a target voltage, and to apply the third voltage to a display panel.

### CROSS-REFERENCE TO RELATED APPLICATION(S)

This application claims priority under 35 U.S.C. § 119 to Korean Patent Application No. 10-2024-0092640, filed on Jul. 12, 2024, in the Korean Intellectual Property Office, the disclosure of which is incorporated by reference herein in its entirety.

### 1. TECHNICAL FIELD

Example embodiments relate to an adaptive voltage control (AVC) circuit and a control method thereof.

### 2. DESCRIPTION OF THE RELATED ART

Mobile devices, such as cell phones, use display panels to present various types of information. As usage environments for mobile devices become increasingly diverse, the voltage patterns applied to display panels also vary significantly. This has created a need for methods to appropriately control the voltage applied to display panels based on specific circumstances. In addition, there is a growing demand for the development of voltage control circuits that enable display driving circuits to apply voltages within an operable range, especially for display panels made from materials different from those traditionally used.

### SUMMARY

Various embodiments of the present disclosure provide an adaptive voltage control (AVC) circuit that regulates the panel driving voltage applied to a display panel and a control method thereof.

According to an example embodiment, there is provided an AVC circuit including: a voltage application circuit configured to apply a first voltage or a second voltage to a voltage output circuit, wherein the first voltage is generated by dividing a panel driving voltage; and the voltage output circuit configured to generate a third voltage based on the first or second voltage received from the voltage application circuit and a target voltage, and to apply the third voltage to a display panel.

According to an example embodiment, there is provided a control method of an AVC circuit, the control method including: identifying a driving mode of the AVC circuit; and controlling the AVC circuit to apply a third voltage to a display panel based on the driving mode, wherein the AVC circuit includes: a voltage application circuit configured to apply a first voltage or a second voltage to a voltage output circuit based on the driving mode, wherein the first voltage is generated by dividing a panel driving voltage; and the voltage output circuit configured to generate the third voltage based on the first or second voltage applied to the voltage output circuit and a target voltage and to apply the third voltage to the display panel.

According to an example embodiment, there is provided a display device including: a power management integrated circuit configured to generate a panel driving voltage; a display driving circuit including an AVC circuit; and a display panel, wherein the AVC circuit includes: a voltage application circuit configured to apply a first voltage or a second voltage to a voltage output circuit, wherein the first voltage is generated by dividing the panel driving voltage; and the voltage output circuit configured to generate a third voltage based on the first or second voltage and a target voltage and to apply the third voltage to the display panel.

According to example embodiments of the present disclosure, an AVC circuit can apply a voltage to a display panel that incorporates a predetermined variation in the panel driving voltage corresponding to changes in the panel's luminance. By doing so, the AVC circuit can track and adapt to changes in panel driving voltage, even in cases of negative low drop out (LDO) output. With advancements in technology, luminance changes in display panels have increased, leading to more diverse patterns in panel driving voltage. Therefore, the AVC circuit according to an example embodiment may perform adaptive voltage control while maintaining a constant slew rate, regardless of the varying patterns in the panel driving voltage.

According to example embodiments of the present disclosure, the AVC circuit can operate exclusively in a middle voltage (MV) range, aligning with recent technology trends aimed at achieving low power consumption in display panels. Further, the AVC circuit according to example embodiments of the present disclosure may include a reduced number of amplifiers for operation in the MV range. This simplified structure minimizes the overall circuit size and current leakage.

Effects of example embodiments are not limited to those described above; additional effects may become apparent those skilled in the art upon reviewing the appended claims.

### BRIEF DESCRIPTION OF THE DRAWINGS

The above and/or other features, and advantages of the present disclosure will become apparent and more readily understood from the following description of example embodiments, taken in conjunction with the accompanying drawings of which:

FIG. 1 is a diagram for illustrating a structure of an adaptive voltage control (AVC) circuit according to an example embodiment;

FIG. 2 is a block diagram for illustrating a display device that performs AVC according to an example embodiment;

FIG. 3 is a circuit diagram showing a pixel included in a display panel according to an example embodiment;

FIG. 4 is a circuit diagram for illustrating a first AVC circuit according to an example embodiment;

FIG. 5 is a circuit diagram for illustrating a second AVC circuit according to an example embodiment;

FIG. 6 is a circuit diagram for illustrating a third AVC circuit according to an example embodiment;

FIG. 7 is a diagram for illustrating a voltage range related to an AVC circuit according to an example embodiment;

FIG. 8 is a diagram for illustrating a simulation result of an AVC circuit according to an example embodiment;

FIG. 9 is a block diagram showing a structure of an electronic apparatus including a display device according to an example embodiment; and

FIG. 10 is a flowchart for illustrating a process of controlling an AVC circuit according to an example embodiment.

### DETAILED DESCRIPTION OF THE EMBODIMENTS

Terms used in the example embodiments are selected from widely used general terminology whenever possible, taking into account their functions in the present disclosure. However, the terms may vary depending on the intent of a person skilled in the art, precedents, the development of new technologies, and the like. Further, in certain cases, specific terms may be defined by the applicant, and their meanings will be explained in detail within the relevant sections. Therefore, the terms used in the present disclosure should not be interpreted solely by their labels but rather understood in light of their defined meanings and the overall context of the disclosure.

Throughout the specification, when a part is described as “comprising or including” a component, it does not exclude another component but may further include another component unless otherwise stated. Furthermore, terms such as “ . . . unit,” “ . . . part,” and “ . . . module” described in the specification may mean a unit that processes at least one function or operation, which may be implemented as hardware, software, or a combination thereof.

The present disclosure addresses limitations in adaptive voltage control (AVC) circuits used in display driver integrated circuits (DDIs), particularly in the context of OLED-on-silicon (OLEDoS) displays. Conventional AVC circuits are designed for high voltage (HV) and middle voltage (MV) ranges in mobile environments. However, modern display panels increasingly rely on MV-range elements to optimize power efficiency. This shift introduces challenges in accommodating changing luminance patterns and ELVSS voltage adjustments within the AVC circuit's operable range. Existing designs do not adequately handle these new requirements, leading to a need for a more adaptable solution.

The present disclosure proposes an AVC circuit design that integrates a buffer structure and multiplexer. This configuration enables the circuit to perform adaptive voltage control by calculating MV-range voltages with minimal amplifier use while accounting for ELVSS voltage changes. In modes requiring adaptive voltage control, the circuit applies a voltage derived from the panel's driving voltage. In non-adaptive modes, it maintains stable output using ground voltage. By combining the buffer and multiplexer structures, the present disclosure ensures precise and efficient voltage control tailored to modern display panel needs, addressing both power consumption and operational versatility.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

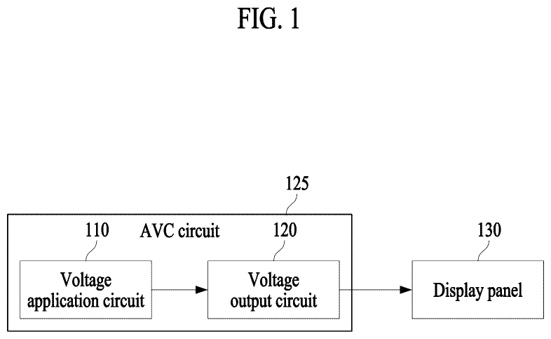

FIG. 1 is a diagram for illustrating a structure of an adaptive voltage control (AVC) circuit according to an example embodiment.

The role of an AVC circuit for tracking changes in panel driving voltage by applying a panel driving voltage that adapts to luminance variations in a display panel is becoming increasingly significant. To reduce power consumption in display driver integrated circuits (DDIs), elements operating in a lower voltage range than the range required for ELVSS panel driving voltage may be predominantly utilized. Therefore, adaptive voltage control may be implemented with consideration for the properties of the DDI that drives pixels included in the display panel. In particular, an organic light emitting diodes on silicon (OLEDOS) display offers improved driving performance by leveraging a silicon wafer substrate instead of a traditional glass substrate. In this structure, a semiconductor process generates the pixels and driving components on a silicon wafer substrate, and an OLED element, acting as the light-emitting component, is subsequently deposited. This design enables higher response speeds compared to conventional glass-based displays. For OLEDOS displays to function under optimal conditions, the role of the AVC circuit becomes even more critical.

Referring to FIG. 1, an AVC circuit 125 according to an example embodiment may include a voltage application circuit 110 and a voltage output circuit 120. The voltage application circuit 110 applies either a first voltage, generated through the division of a panel driving voltage, or a second voltage to a voltage output circuit 120. The voltage output circuit 120 generates a third voltage based on the applied voltage and a target voltage and outputs the third voltage to a display panel 130.

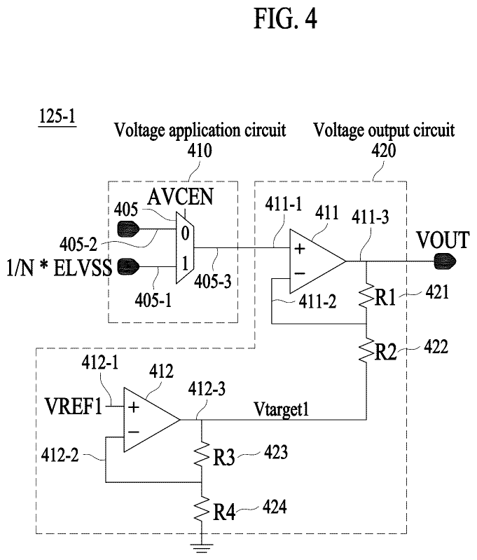

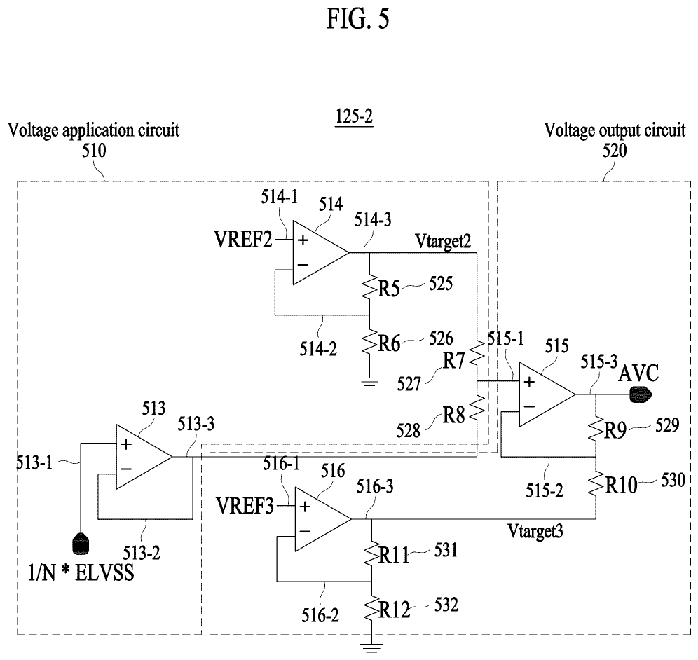

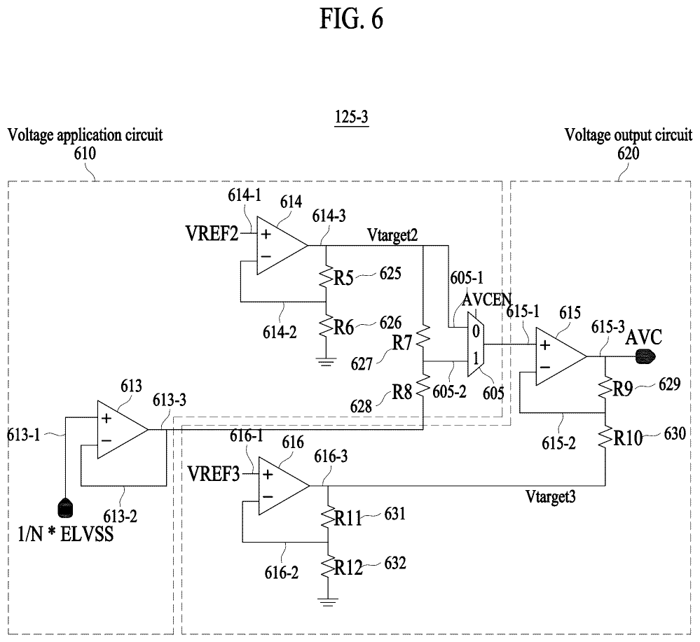

The voltage application circuit 110 according to an example embodiment may provide either a first voltage, generated through the division of a panel driving voltage, or a second voltage to the voltage output circuit 120. The first voltage may be generated dividing the ELVSS panel driving voltage by a predetermined ratio N and may be used to supply a third-first voltage to the display panel 130 when the AVC circuit 125 is driven in a first mode. The second voltage, which may correspond to a ground voltage, can be used to supply a third-second voltage to the display panel 130 when the AVC circuit 125 is driven in a second mode. The voltage application circuit 110 according to an example embodiment may include a first multiplexer 405 like a voltage application circuit 410 of a first AVC circuit 125-1 in FIG. 4 described below and may include a third amplifier 513 and a fourth amplifier 514 like a voltage application circuit 510 of a second AVC circuit 125-2 in FIG. 5 described below. In addition, the voltage application circuit 110 according to an example embodiment may include a third amplifier 613, a fourth amplifier 614, and a second multiplexer 605 like a voltage application circuit 610 of a third AVC circuit 125-3 in FIG. 6 described below.

The voltage output circuit 120 according to an example embodiment may generate a third voltage based on a voltage applied thereto and a target voltage and output the third voltage to the display panel 130. The voltage output circuit 120 according to an example embodiment may supply different voltages to the display panel 130 depending on each operating mode of the AVC circuit 125. When the AVC circuit 125 operates in the first mode for performing adaptive voltage control, the voltage output circuit 120 applies a voltage for that mode. When the AVC circuit 125 operating in the second mode where adaptive voltage control is not performed, the voltage output circuit 120 provides a different voltage to the display panel 130. The AVC circuit 125 according to an example embodiment to be described below may be driven exclusively in the first mode, as with the second AVC circuit 125-2 of FIG. 5. Alternatively, the AVC circuit 125 may switch between the first mode and the second mode, as in the first AVC circuit 125-1 and the third AVC circuit 125-3 of FIGS. 4 and 6. However, these examples are not intended to limit the scope of the present disclosure.

The display panel 130 according to an example embodiment may display images. The display panel 130 may include scanning lines (or gate lines), data lines, and a pixel PXL. The pixel PXL may be disposed in an area (for example, a pixel area) separated by the scanning lines and the data lines. The pixel PXL may be connected to at least one of the scanning lines and one of the data lines. In addition, the pixel PXL may be electrically connected between a power line to which a positive output driving voltage is applied and a power line to which a panel driving voltage is applied. Here, the panel driving voltage and the positive output driving voltage may serve as driving voltages for the operation of the pixel PXL, and the positive output driving voltage may have a higher voltage level than the panel driving voltage. The panel driving voltage and the positive output driving voltage may be provided to the display panel 130 from a power management integrated circuit 210. The pixel PXL may store or record a data signal (or a data voltage) transferred from a display driving circuit 220 in response to a scanning signal provided through a scanning line and emit light at a luminance corresponding to the stored data signal.

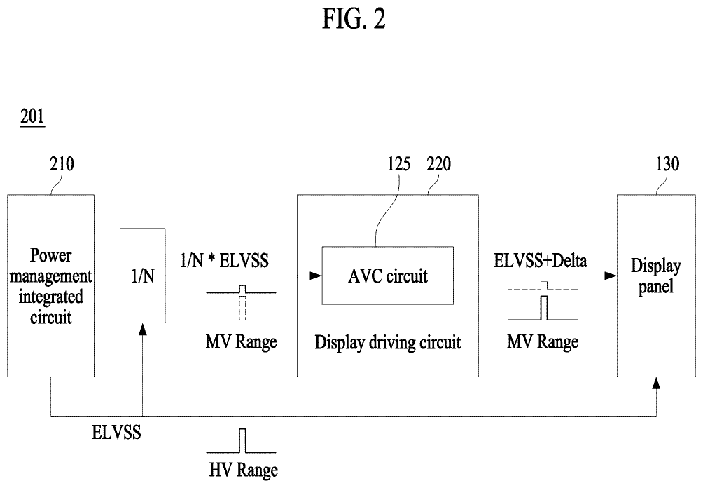

FIG. 2 is a block diagram for illustrating a display device that performs adaptive voltage control according to an example embodiment.

Referring to FIG. 2, a structure of the display device may be observed when the AVC circuit 125 according to an example embodiment is driven in a first mode for performing adaptive voltage control. A display device 201 that performs adaptive voltage control according to an example embodiment may include the power management integrated circuit 210, the display driving circuit 220 including the AVC circuit 125, and the display panel 130. The AVC circuit 125 applies a third-first voltage to the display panel 130, which includes a panel driving voltage and a predetermined variation.

The power management integrated circuit (PMIC) 210 according to an example embodiment may supply panel driving voltages (for example, ELVSS and ELVDD) to the display panel 130. In addition, when the AVC circuit 125 is driven in the first mode, the power management integrated circuit 210 may supply a first voltage to the AVC circuit 125. The first voltage is generated through voltage division, where the ELVSS panel driving voltage is divided by the predetermined ratio N. In an example embodiment, the first voltage may be included in a first voltage range (for example, a middle voltage (MV) range), and the panel driving voltage may belong to a second voltage range (for example, a high voltage (HV) range) which is outside the first voltage range. In other words, the power management integrated circuit 210 may supply the first voltage included in the first voltage range to the AVC circuit 125 by dividing the panel driving voltage that belongs to the second voltage range. Specifically, the power management integrated circuit 210 generates the first voltage within the MV range by dividing the panel driving voltage from the HV range and supplies this to the AVC circuit 125. The power management integrated circuit 210 may provide the panel driving voltages (for example, ELVSS and ELVDD) to one side of the display panel 130. Hereinafter, the first voltage range may refer to a voltage range in which the AVC circuit 125 according to an example embodiment is driven and, for example, may refer to a voltage range between 0 volt (V) and 3 V corresponding to the MV range in which the AVC circuit 125 is driven as illustrated in FIG. 1. Hereinafter, the second voltage range may refer to a range outside the first voltage range in which the AVC circuit 125 according to an example embodiment is driven and, for example, may refer to a voltage range between 8 V and −10 V corresponding to the HV range as also shown in FIG. 1. This HV range encompasses the ELVSS panel driving voltage but lies outside the 0 V and 3 V range of the first voltage range. According to an example embodiment, when being driven in the first mode to perform adaptive voltage control, the AVC circuit 125 may generate a first voltage within the MV range by dividing a panel driving voltage from the HV range. The AVC circuit 125 the applies a third-first voltage to the display panel 130. This third-first voltage reflects continuous variations of the ELVSS panel driving voltage, including the ELVSS panel driving voltage itself and a predetermined variation, within the MV range.

The display driving circuit 220 may include the AVC circuit 125. The display driving circuit 220 may transfer a data voltage (or a data signal) to the display panel 130. The display driving circuit 220 may consist of, for example, a plurality of data driver integrated circuits (IC) and may generate a data signal based on a red-green-blue (RGB) data signal and a control signal and apply the generated data signal to the display panel 130. The AVC circuit 125, when driven in the first mode, may include the voltage application circuit 110 that applies the first voltage generated through voltage division of the panel driving voltage to the voltage output circuit 120. For example, the voltage application circuit 110 may apply the first voltage to the voltage output circuit 120 when the AVC circuit 125 is driven in the first mode to perform adaptive voltage control. In addition, the AVC circuit 125 may include the voltage output circuit 120, which generates the third-first voltage based on the voltage applied to the voltage output circuit 120 and a target voltage. This third-first voltage incorporates the panel driving voltage and a predetermined variation, which is then applied to the display panel 130. The predetermined variation may be determined, for example, based on the target voltage of the first mode.

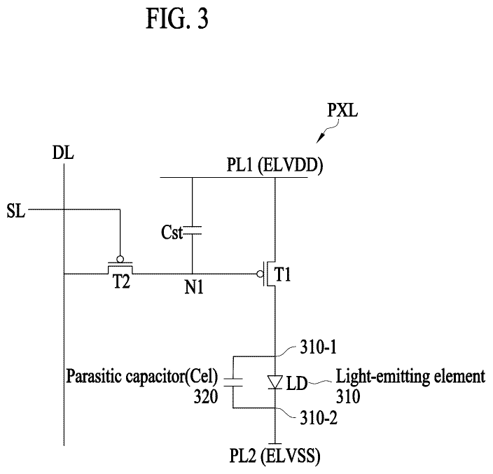

FIG. 3 is a circuit diagram showing a pixel included in a display panel according to an example embodiment.

Referring to FIG. 3, the pixel PXL included in the display panel 130 may be connected to a scanning line SL and a data line DL. The pixel PXL may include a light-emitting element LD, first and second transistors T1 and T2, a storage capacitor Cst, and a diode capacitor Cel. An anode electrode of the light-emitting element LD may be connected to a power line PL1 via the first transistor T1, and a cathode electrode of the light-emitting element LD may be connected to a power line PL2. A positive output power voltage ELVDD may be applied to the power line PL1, and the panel driving voltage ELVSS may be applied to the power line PL2. The light-emitting element LD may be OLEDoS. The light-emitting element LD may consist of an organic light emitting diode or an inorganic light emitting diode such as micro LED and quantum LED. In addition, the light-emitting element LD may be a light emitting diode formed by combining an organic material and an inorganic material. A first electrode of the first transistor T1 (or a driving transistor) may be connected to the power line PL1, and a second electrode of the first transistor T1 may be connected to the anode electrode of the light-emitting element LD. A gate electrode of the first transistor T1 may be connected to a first node N1. The first transistor T1 may regulate the amount of driving current supplied to the light-emitting element LD based on the voltage at the first node N1. A first electrode of the second transistor T2 (or a switching transistor) may be connected to the data line DL, and a second electrode of the second transistor T2 may be connected to the first node N1. A gate electrode of the second transistor T2 may be connected to the scanning line SL.

The storage capacitor Cst may be formed or connected between the first node N1 and the power line PL1. For example, a first electrode of the storage capacitor Cst may be connected to the first node N1 and a second electrode of the storage capacitor Cst may be connected to the power line PL1. The storage capacitor Cst may be charged to a voltage corresponding to a data signal of one frame supplied to the first node N1 and may retain this charged voltage until a data signal for a following frame is supplied. When a scanning signal of a turn-on level (low level) is supplied through the i-th scanning line SL to the gate electrode of the second transistor T2, the second transistor T2 may connect the data line DL to the first electrode of the storage capacitor Cst. Accordingly, a voltage corresponding to the difference between the data signal (or data voltage) applied through the data line DL and the positive output power voltage ELVDD may be programmed onto the storage capacitor Cst. The first transistor T1 may allow a driving current, determined by the voltage programmed on the storage capacitor Cst, to flow from the power line PL1 to the power line PL2. The light-emitting element LD may emit light with luminance proportional to the volume of the driving current.

The diode capacitor Cel according to an example embodiment may correspond to a parasitic capacitor 320 inherent to light-emitting element 310 (also referred to as ‘LD’) and may connected between an anode electrode 310-1 of the light-emitting element 310 and a cathode electrode 310-2 of the light-emitting element 310. The voltage output circuit 120 according to an example embodiment may apply a third voltage to the anode electrode 310-1 of the light-emitting element 310 included in the display panel 130. In an example embodiment, a panel driving voltage may be applied to the cathode electrode 310-2 of the light-emitting element 310, and the panel driving voltage and the third voltage may be applied to opposite ends of the diode capacitor Cel. For convenience of description, FIG. 3 illustrates a relatively simple structure of a pixel circuit including the second transistor T2 for transferring a data signal inside the pixel PXL, the storage capacitor Cst for storing the data signal, and the first transistor T1 for supplying a driving current corresponding to the data signal to the light-emitting element LD. However, example embodiments of the present disclosure are not limited thereto, and a structure of the pixel circuit may be modified and implemented in various ways. As an example, the pixel circuit may further include various transistors such as a compensation transistor for compensating a threshold voltage of the first transistor T1, an initialization transistor for initializing the first node N1 or an anode electrode of the light-emitting element LD, and/or a light-emitting control transistor for controlling a light-emitting time of the light-emitting element LD. In addition, FIG. 3 illustrates the first and second transistors T1 and T2 as p-type transistors but is not limited thereto, and the pixel PXL may also include, for example, an n-type transistor. For example, according to a structure of the pixel circuit, the voltage output circuit 120 may apply the third voltage to the cathode electrode 310-2 of the light-emitting element 310, and the panel driving voltage ELVSS may also be applied to the anode electrode 310-1 of the light-emitting element 310. However, the descriptions above are merely examples, and example embodiments of the present disclosure are not limited to the voltage output circuit 120 applying the third voltage to a specific electrode of the light-emitting element 310.

FIG. 4 is a circuit diagram for illustrating a first AVC circuit according to an example embodiment.

Referring to FIG. 4, the first AVC circuit 125-1 according to an example embodiment may be driven in a first mode to perform adaptive voltage control or a second mode where adaptive voltage control is not performed. The voltage application circuit 410 of the first AVC circuit 125-1 according to an example embodiment may include the first multiplexer 405 including a first input terminal 405-1 to which a first voltage is applied, a second input terminal 405-2 to which a second voltage is applied, and an output terminal 405-3. The first multiplexer 405 according to an example embodiment may function as an element that selects one input signal from a plurality of input signals based on a specific driving mode and outputs it as an output signal. Additionally, the first multiplexer 405 may include a control signal receiving terminal AVCEN that receives a control signal from an external element (for example, a processor). When the first AVC circuit 125-1 is driven in the first mode to perform adaptive voltage control based on a control signal, the first multiplexer 405 may supply the first voltage to a voltage output circuit 420. Conversely, when the first AVC circuit 125-1 is driven in the second mode where adaptive voltage control is not performed, the first multiplexer 405 may supply the second voltage to the voltage output circuit 420.

The voltage output circuit 420 of the first AVC circuit 125-1 according to an example embodiment may include a first amplifier 411 including a first input terminal 411-1 to which the first voltage or the second voltage is applied from the voltage application circuit 410, a second input terminal 411-2, and an output terminal 411-3 that outputs a third voltage. The first amplifier 411 may correspond to an operational amplifier (OP-amp) and may further include power terminals that receive a positive power terminal voltage (vdd) and a negative power terminal voltage (vss), which are used to operate the first amplifier 411. This configuration is similar to the other amplifiers described below. The first amplifier 411 may correspond to, for example, an amplifier that operates within a first voltage range. The voltage output circuit 420 of the first AVC circuit 125-1 according to an example embodiment may include first resistor 421 connected between the output terminal 411-3 of the first amplifier 411 and the second input terminal 411-2 of the first amplifier 411 and second resistor 422 connected between the first resistor 421 and an output terminal 412-3 of a second amplifier 412. A ratio of the first resistor 421 to the second resistor 422 may be determined based on a ratio of a panel driving voltage to the first voltage. For example, the ratio of the panel driving voltage to the first voltage and the ratio of the first resistor 421 to the second resistor 422 may be expressed as shown in the following equation 1.

$${V}_{1} = \frac{1}{N} \times ELVSS \qquad [ Equation 1 ]$$

$$\frac{{R}_{1}}{{R}_{2}} = N - 1$$

In equation 1, V₁ may represent the first voltage, ELVSS may represent the panel driving voltage, N may represent the ratio of the panel driving voltage to the first voltage, and R₁ and R₂ may represent a magnitude of the first resistor 421 and a magnitude of the second resistor 422 respectively.

When the first AVC circuit 125-1 is driven in the first mode to perform adaptive voltage control, the first AVC circuit 125-1 may apply a third-first voltage including the panel driving voltage and a predetermined variation to the display panel 130. For example, when the first AVC circuit 125-1 is driven in the first mode, the first amplifier 411 according to an example embodiment may apply the third-first voltage to the display panel 130 based on the following equation 2.

$${V}_{3 - 1} = ELVSS + Delta \qquad [ Equation 2 ]$$

$$Delta = - ( N - 1 ) \times Vtarget {1}_{1}$$

In equation 2, V₃₋₁ may represent the third-first voltage applied to the display panel 130 when the first AVC circuit 125-1 is driven in the first mode. In equation 2, ELVSS may represent the panel driving voltage, and Delta may represent the predetermined variation. N may represent the ratio of the panel driving voltage to the first voltage, and Vtarget1₁ may represent a first-first target voltage of the first mode.

For example, to describe a specific operation of the first AVC circuit 125-1 performing adaptive voltage control in the first mode with respect to equation 2, we assume that the first AVC circuit 125-1 is driven under the condition that ELVSS, which is the panel driving voltage, corresponds to −10 V and a voltage applied to the display panel 130 is −3 V. When the ratio N of the panel driving voltage to the first voltage corresponds to 5 and the first voltage is −2 V, the panel driving voltage can exhibit a stepwise increasing pattern, for example, from −10 V to −8 V. According to equation 2, a value of Delta may be +7 V and the first-first target voltage of the first mode may be about −1.75 V. The third-first voltage V₃₋₁ may increase stepwise from −3 V to −1 V following the same changing pattern of the panel driving voltage. However, it consistently maintains a voltage difference of 7 V above the panel driving voltage. To determine the corresponding first-first target voltage in the first mode, a first reference voltage, a third resistor 423, and a fourth resistor 424 to be described below may be determined.

For example, when the first AVC circuit 125-1 operates in the second mode, which does not perform adaptive voltage control, the first amplifier 411 according to an example embodiment may apply a third-second voltage to the display panel 130. The third-second voltage is based on a first-second target voltage of the second mode, as described by equation 3.

$${V}_{3 - 2} = N \times {V}_{2} - ( N - 1 ) \times Vtarget {1}_{2} \qquad [ Equation 3 ]$$

In equation 3, V₃₋₂ may represent the third-second voltage applied to the display panel 130 when the first AVC circuit 125-1 is driven in the second mode. In equation 3, V₂ may correspond to a voltage applied to the voltage output circuit 420 by the voltage application circuit 410 in the second mode and, for example, may be a ground voltage. N may represent the ratio of the panel driving voltage to the first voltage, and Vtarget1₂ may represent the first-second target voltage of the second mode.

For example, when describing a specific operation of the first AVC circuit 125-1 in the second mode, where adaptive voltage control is not performed, as defined by equation 3, it may be assumed that the first AVC circuit 125-1 operates under the condition that ELVSS, which is the panel driving voltage, is −10 V and a voltage applied to the display panel 130 is −3 V. When the ratio N of the panel driving voltage to the first voltage is 5 and the first voltage is −2 V, the panel driving voltage may increase stepwise from −10 V to −8 V, for example. Regardless of changes in the panel driving voltage, the voltage output circuit 420 may consistently apply −3 V as the third-second voltage to the display panel 130, and thus, the first-second target voltage of the second mode may be 0.75 V. To determine the first-second target voltage of the second mode, the first reference voltage, the third resistor 423, and the fourth resistor 424 to be described below may be determined. In other words, to achieve the first-first target voltage of the first mode (when the first AVC circuit 125-1 performs adaptive voltage control) and the first-second target voltage of the second mode (when adaptive voltage control is not performed), the first reference voltage to be applied to the first AVC circuit 125-1 is determined separately for each mode. This determination depends on each of the first mode and the second mode.

The voltage output circuit 420 of the first AVC circuit 125-1 according to an example embodiment may include the second amplifier 412 including a first input terminal 412-1 to which the first reference voltage (VREF1) is applied, a second input terminal 412-2, and the output terminal 412-3 that outputs a first target voltage (Vtarget1). The voltage output circuit 420 of the first AVC circuit 125-1 may include the third resistor 423 connected between the output terminal 412-3 of the second amplifier 412 and the second input terminal 412-2 of the second amplifier 412 and the fourth resistor 424 connected between the second input terminal 412-2 of the second amplifier 412 and a ground terminal. As described above, the first-first target voltage of the first mode of the first AVC circuit 125-1 according to an example embodiment may be determined based on a first-first reference voltage of the first mode, a magnitude of the third resistor 423, and a magnitude of the fourth resistor 424. The first-first reference voltage may be determined based on the value of the first-first target voltage, which is used to establish the predetermined variation included in the third-first voltage applied to the display panel 130 by the first AVC circuit 125-1 when performing adaptive voltage control. Similarly, the first-second target voltage of the second mode may be determined based on a first-second reference voltage of the second mode, a magnitude of the third resistor 423, and a magnitude of the fourth resistor 424. The first-second reference voltage may be determined based on the value of the first-second target voltage, which establishes the third-second voltage applied to the display panel 130 by the first AVC circuit 125-1 when not performing adaptive voltage control.

As described with reference to FIG. 4, the first AVC circuit 125-1 in the first mode, which performs adaptive voltage control according to an example embodiment, may generate the first voltage through voltage division of the panel driving voltage and supply it as an input to the voltage application circuit 410 of the first AVC circuit 125-1. Adaptive voltage control may then be performed based on the magnitude relationship between the first resistor 421 and the second resistor 422 included in the voltage output circuit 420 of the first AVC circuit 125-1. In other words, the first AVC circuit 125-1 may adaptively control voltage by applying changes in the panel driving voltage to a low drop out (LDO) output of the voltage output circuit 420 and supplying the third-first voltage to the display panel 130. The first AVC circuit 125-1 according to an example embodiment may calculate the first voltage and the third voltage within the first voltage range, which is the operating voltage range of the first AVC circuit 125-1, and perform adaptive voltage control using only two amplifiers, the first amplifier 411 and the second amplifier 412. Notably, this process does not require direct calculation of the panel driving voltage in the second voltage range, which is outside the first voltage range.

FIG. 5 is a circuit diagram for illustrating a second AVC circuit according to an example embodiment.

Referring to FIG. 5, the second AVC circuit 125-2 according to an example embodiment may be driven in the first mode to perform adaptive voltage control. The voltage application circuit 510 of the second AVC circuit 125-2 according to an example embodiment may include the third amplifier 513 including a first input terminal 513-1 to which the first voltage generated through voltage division of the panel driving voltage is applied, a second input terminal 513-2, and an output terminal 513-3. The second input terminal 513-2 of the third amplifier 513 and the output terminal 513-3 of the third amplifier 513 may be connected to each other. In other words, the voltage application circuit 510 of the second AVC circuit 125-2 may apply the first voltage, which is supplied to the first input terminal 513-1 of the third amplifier 513. This voltage, influenced by noise introduced through the buffer structure of the third amplifier 513, is then output from the output terminal 513-3 of the third amplifier 513 and applied to a voltage output circuit 520 of the second AVC circuit 125-2. The voltage application circuit 510 of the second AVC circuit 125-2 according to an example embodiment may include the fourth amplifier 514 including a first input terminal 514-1 to which a second reference voltage (VREF2) is applied, a second input terminal 514-2, and an output terminal 514-3 that outputs a second target voltage (Vtarget2). The voltage application circuit 510 of the second AVC circuit 125-2 according to an example embodiment may include fifth resistor 525 connected between the output terminal 514-3 of the fourth amplifier 514 and the second input terminal 514-2 of the fourth amplifier 514 and sixth resistor 526 connected between the second input terminal 514-2 of the fourth amplifier 514 and a ground terminal. The second target voltage according to an example embodiment may fall within the first voltage range. The second target voltage outputted by the output terminal 514-3 of the fourth amplifier 514 may be determined based on the second reference voltage, a magnitude of the fifth resistor 525, and a magnitude of the sixth resistor 526. When the second target voltage is determined in the voltage application circuit 510 of the second AVC circuit 125-2, the second reference voltage to be applied to the first input terminal 514-1 of the fourth amplifier 514 may be determined based on the determined second target voltage. The voltage application circuit 510 of the second AVC circuit 125-2 according to an example embodiment may include a seventh resistor 527 connected to the output terminal 514-3 of the fourth amplifier 514 and a fifth amplifier 515 and an eighth resistor 528 connected to the seventh resistor 527 and the output terminal 513-3 of the third amplifier 513. The voltage application circuit 510 may apply a voltage derived from the division of the first voltage and the second target voltage, based on the magnitude relationship between the seventh resistor 527 and the eighth resistor 528, to the voltage output circuit 520. The magnitude of the seventh resistor 527 and the magnitude of the eighth resistor 528 may be identical to each other. In other words, the voltage application circuit 510 of the second AVC circuit 125-2 according to an example embodiment may apply a voltage equivalent to the average of the first voltage and the second target voltage. This is achieved through voltage division, where the magnitudes of the seventh resistor 527 and the eighth resistor 528 are identical, and the resulting voltage is supplied to the voltage output circuit 520.

The voltage output circuit 520 of the second AVC circuit 125-2 according to an example embodiment may include the fifth amplifier 515 including a first input terminal 515-1 connected between the seventh resistor 527 and the eighth resistor 528, a second input terminal 515-2, and an output terminal 515-3 that outputs the third voltage. A voltage corresponding to the average of the first voltage and the second target voltage may be applied to the first input terminal 515-1 of the fifth amplifier 515. The voltage output circuit 520 of the second AVC circuit 125-2 according to an example embodiment may include a ninth resistor 529 connected between the output terminal 515-3 of the fifth amplifier 515 and the second input terminal 515-2 of the fifth amplifier 515 and a tenth resistor 530 connected between the ninth resistor 529 and an output terminal 516-3 of a sixth amplifier 516. A ratio of the ninth resistor 529 to the tenth resistor 530 may be determined based on a ratio of the panel driving voltage to the first voltage. For example, the ratio of the panel driving voltage to the first voltage and the ratio of the ninth resistor 529 to the tenth resistor 530 may be expressed as shown in the following equation 4.

$${V}_{1} = \frac{1}{N} \times ELVSS \qquad [ Equation 4 ]$$

$$\frac{{R}_{9}}{{R}_{10}} = 2 N - 1$$

In equation 4, V₁ may represent the first voltage, ELVSS may represent the panel driving voltage, N may represent the ratio of the panel driving voltage to the first voltage, and R₉ and R₁₀ may represent a magnitude of the ninth resistor 529 and a magnitude of the tenth resistor 530 respectively.

The voltage output circuit 520 of the second AVC circuit 125-2 according to an example embodiment may include the sixth amplifier 516 including a first input terminal 516-1 to which a third reference voltage (VREF2) is applied, a second input terminal 516-2, and the output terminal 516-3. The voltage output circuit 520 may include an eleventh resistor 531 connected between the output terminal 516-3 of the sixth amplifier 516 and the second input terminal 516-2 of the sixth amplifier 516 and a twelfth resistor 532 connected between the second input terminal 516-2 of the sixth amplifier 516 and a ground terminal. The sixth amplifier 516 may correspond to, for example, an amplifier driven in the first voltage range. A third target voltage (Vtarget3) outputted by the output terminal 516-3 of the sixth amplifier 516 may be determined based on the second reference voltage, a magnitude of the eleventh resistor 531, and a magnitude of the twelfth resistor 532. When the third target voltage is determined in the voltage output circuit 520 of the second AVC circuit 125-2, the third reference voltage to be applied to the first input terminal 516-1 of the sixth amplifier 516 may be established based on the determined third target voltage.

The fifth amplifier 515 included in the voltage output circuit 520 of the second AVC circuit 125-2 according to an example embodiment may apply the third voltage to the display panel 130 based on the following equation, for example.

$${V}_{3} = ELVSS + Delta \qquad [ Equation 5 ]$$

$$Delta = N \times Vtarget 2 - ( 2 N - 1 ) \times Vtarget 3$$

In equation 5, V₃ may represent the third voltage applied to the display panel 130 by the second AVC circuit 125-2. In equation 5, ELVSS may represent the panel driving voltage, and Delta may represent the predetermined variation. N may represent the ratio of the panel driving voltage to the first voltage, and Vtarget2 and Vtarget3 may represent the second target voltage and the third target voltage respectively.

For example, when describing a specific operation of the second AVC circuit 125-2 with reference to equation 5, it can be assumed that the second AVC circuit 125-2 operates under the condition that ELVSS, which is the panel driving voltage, is −10 V and a voltage applied to the display panel 130 is −3 V. When the ratio N of the panel driving voltage to the first voltage is 5 and the first voltage is −2 V, the panel driving voltage may increase stepwise from −10 V to −8 V, for example. According to equation 5, the value of Delta may be +7 V, and each of the second target voltage and the third target voltage may be set freely within a range that satisfies the condition specified in equation 5. More specifically, the second target voltage according to an example embodiment may be determined based on the second reference voltage, the fifth resistor 525, and the sixth resistor 526 provided it falls within the first voltage range. Conversely, each of the second reference voltage, the fifth resistor 525, and the sixth resistor 526 may be determined based on the determined second target voltage. In addition, the third target voltage according to an example embodiment may be determined based on the third reference voltage, the eleventh resistor 531, and the twelfth resistor 532 while also remaining within the first voltage range. Conversely, each of the third reference voltage, the eleventh resistor 531, and the twelfth resistor 532 may be determined based on the determined third target voltage. The third voltage V₃ may increase stepwise from −3 V to −1 V in alignment with the stepwise increase of the panel driving voltage, while maintaining a voltage difference of 7 V above the panel driving voltage.

Therefore, as described with reference to FIG. 5, the second AVC circuit 125-2 according to an example embodiment may apply a voltage corresponding to the average value of the first voltage (generated through voltage division of the panel driving voltage) and the second target voltage. This voltage is applied to the voltage output circuit 520 through the voltage application circuit 510 of the second AVC circuit 125-2, enabling adaptive voltage control based on the magnitude relationship between the ninth resistor 529 and the tenth resistor 530, which are part of the voltage output circuit 520. In other words, the second AVC circuit 125-2 may perform adaptive voltage control by applying changes in the panel driving voltage to the LDO output of the voltage output circuit 520 and supplying the third voltage to the display panel 130. The second AVC circuit 125-2 calculates the first voltage and the third voltage within the first voltage range (e.g., the operational range of the second AVC circuit 125-2), and performs adaptive voltage control using only four amplifiers: the third amplifier 513, which includes a buffer structure; the fourth amplifier 514, which outputs the second target voltage; the sixth amplifier 516, which outputs the third target voltage; and the fifth amplifier 515, which applies the third voltage to the display panel 130. Notably, this process does not involve direct calculation of the panel driving voltage in the second voltage range, which is outside the first voltage range.

FIG. 6 is a circuit diagram for illustrating a third AVC circuit according to an example embodiment.

Referring to FIG. 6, the third AVC circuit 125-3 according to an example embodiment may be driven in a first mode to perform adaptive voltage control or a second mode in which adaptive voltage control is not performed. The voltage application circuit 610 of the third AVC circuit 125-3 according to an example embodiment may include the third amplifier 613 including a first input terminal 613-1 to which the first voltage generated through voltage division of the panel driving voltage is applied, a second input terminal 613-2, and an output terminal 613-3. As described in FIG. 5, the voltage application circuit 610 of the third AVC circuit 125-3 may apply the first voltage, which is supplied to the first input terminal 613-1 of the third amplifier 613. This voltage, influenced by noise introduced through the buffer structure of the third amplifier 613, is output from the output terminal 613-3 of the third amplifier 613 and supplied to a voltage output circuit 620 of the third AVC circuit 125-3.

The voltage application circuit 610 of the third AVC circuit 125-3 according to an example embodiment may include the fourth amplifier 614 including a first input terminal 614-1 to which the second reference voltage (VREF2) is applied, a second input terminal 614-2, and an output terminal 614-3 that outputs the second target voltage (Vtarget2). The voltage output circuit 620 may include a fifth resistor 625 connected between the output terminal 614-3 of the fourth amplifier 614 and the second input terminal 614-2 of the fourth amplifier 614 and a sixth resistor 626 connected between the second input terminal 614-2 of the fourth amplifier 614 and a ground terminal. The voltage application circuit 610 may include a seventh resistor 627 connected to the output terminal 614-3 of the fourth amplifier 614 and a fifth amplifier 615 and an eighth resistor 628 connected to the seventh resistor 627 and the output terminal 613-3 of the third amplifier 613.

The voltage application circuit 610 of the third AVC circuit 125-3 according to an example embodiment may include the second multiplexer 605 including a first input terminal 605-1 to which the second target voltage is applied from the fourth amplifier 614, a second input terminal 605-2 connected between the seventh resistor 627 and the eighth resistor 628, and an output terminal connected to a first input terminal 615-1 of the fifth amplifier 615. Similarly to the above descriptions regarding FIG. 5, a voltage divided from the first voltage and the second target voltage based on a relationship between a magnitude of the seventh resistor 627 and a magnitude of the eighth resistor 628 may be applied to the second input terminal 605-2 of the second multiplexer 605. The magnitude of the seventh resistor 627 and the magnitude of the eighth resistor 628 may be identical to each other. In other words, the voltage application circuit 610 of the third AVC circuit 125-3 according to an example embodiment may apply a voltage equivalent to the average of the first voltage and the second target voltage. This is achieved through voltage division, where the magnitudes of the seventh resistor 627 and the eighth resistor 628 identical, and the resulting voltage is supplied to the voltage output circuit 620.

Similar to the first multiplexer 405 described above, the second multiplexer 605 according to an example embodiment may further include a control signal receiving terminal that receives a control signal from an external element (for example, a processor). When the third AVC circuit 125-3 is driven in the first mode to perform adaptive voltage control, the second multiplexer 605 according to an example embodiment may apply a voltage corresponding to an average value of the first voltage and a second-first target voltage of the first mode to the voltage output circuit 620. When the third AVC circuit 125-3 is driven in the second mode in which adaptive voltage control is not performed, the second multiplexer 605 according to an example embodiment may apply a second-second target voltage of the second mode to the voltage output circuit 620.

The voltage output circuit 620 of the third AVC circuit 125-3 according to an example embodiment may include the fifth amplifier 615 including the first input terminal 615-1 to which a voltage corresponding to the average value of the first voltage and the second-first target voltage of the first mode is applied when the third AVC circuit 125-3 is driven in the first mode and the second-second target voltage of the second mode is applied when the third AVC circuit 125-3 is driven in the second mode, a second input terminal 615-2, and an output terminal 615-3 that outputs the third voltage. The voltage output circuit 620 may include a ninth resistor 629 connected between the output terminal 615-3 of the fifth amplifier 615 and the second input terminal 615-2 of the fifth amplifier 615 and a tenth resistor 630 connected between the ninth resistor 629 and an output terminal 616-3 of a sixth amplifier 616. The voltage output circuit 620 may include the sixth amplifier 616 including a first input terminal 616-1 to which the third reference voltage (VREF3) is applied, a second input terminal 616-2, and the output terminal 616-3 that outputs the third target voltage (Vtarget3). The voltage output circuit 620 may include an eleventh resistor 631 connected between the output terminal 616-3 of the sixth amplifier 616 and the second input terminal 616-2 of the sixth amplifier 616 and a twelfth resistor 632 connected between the second input terminal 616-2 of the sixth amplifier 616 and a ground terminal. Hereinafter, descriptions of the fourth amplifier 614 to the sixth amplifier 616 and the fifth resistor 625 to the twelfth resistor 632 may be omitted as they duplicate the descriptions of the fourth amplifier 514 to the sixth amplifier 516 and the fifth resistor 525 to the twelfth resistor 532 described with reference to FIG. 5.

In an example embodiment, a ratio of the ninth resistor 629 to the tenth resistor 630 may be determined based on a ratio of the panel driving voltage to the first voltage. For example, the ratio of the panel driving voltage to the first voltage and the ratio of the ninth resistor 629 to the tenth resistor 630 may be defined in a manner similar to equation 4 described above and, more specifically, may be expressed as shown in equation 6.

$${V}_{1} = \frac{1}{N} \times ELVSS \qquad [ Equation 6 ]$$

$$\frac{{R}_{9}}{{R}_{10}} = 2 N - 1$$

In equation 6, V₁ may represent the first voltage, ELVSS may represent the panel driving voltage, N may represent the ratio of the panel driving voltage to the first voltage, and R₉ and R₁₀ may represent a magnitude of the ninth resistor 629 and a magnitude of the tenth resistor 630 respectively.

When the third AVC circuit 125-3 is driven in the first mode to perform adaptive voltage control, the fifth amplifier 615 according to an example embodiment may apply the third-first voltage to display panel 130. For example, when the third AVC circuit 125-3 is driven in the first mode, the fifth amplifier 615 according to an example embodiment may apply the third-first voltage including the panel driving voltage and the predetermined variation to the display panel 130 as defined by equation 7.

$${V}_{3 - 1} = ELVSS + Delta \qquad [ Equation 7 ]$$

$$Delta = 2 N \times Vtarget {2}_{1} - ( 2 N - 1 ) \times Vtarget {3}_{1}$$

In equation 7, V₃₋₁ may represent the third-first voltage applied to the display panel 130 when the third AVC circuit 125-3 is driven in the first mode to perform adaptive voltage control. In equation 7, ELVSS may represent the panel driving voltage, and Delta may represent the predetermined variation. N may represent the ratio of the panel driving voltage to the first voltage, and Vtarget2₁ and Vtarget3₁ may represent the second-first target voltage of the first mode of the third AVC circuit 125-3 and a third-first target voltage of the first mode of the third AVC circuit 125-3 respectively. The second-first target voltage of the first mode may be determined based on a second-first reference voltage of the first mode, a magnitude of the fifth resistor 625, and a magnitude of the sixth resistor 626. The third-first target voltage of the first mode may be determined based on a third-first reference voltage of the first mode, a magnitude of the eleventh resistor 631, and a magnitude of the twelfth resistor 632. The second-first reference voltage may be determined based on the value of the second-first target voltage, which is used to establish the predetermined variation included in the third-first voltage applied to the display panel 130 by the third AVC circuit 125-3 during adaptive voltage control. Similarly, the third-first reference voltage may be determined based on the value of the third-first target voltage, which is used to establish the predetermined variation included in the third-first voltage applied to the display panel 130 by the third AVC circuit 125-3 during adaptive voltage control.

Similar to that described with reference to FIG. 4, when describing a specific operation of the third AVC circuit 125-3 performing adaptive voltage control in the first mode as defined by equation 7, it may be assumed that the third AVC circuit 125-3 operates under conditions where ELVSS, which is the panel driving voltage, is −10 V and a voltage applied to the display panel 130 is −3 V. The ratio N of the panel driving voltage to the first voltage may be 5, with the first voltage set to −2 V. The panel driving voltage may increase stepwise from −10 V to −8 V, for example. According to equation 7, the value of Delta may be +7 V, and each of the second-first target voltage of the first mode and the third-first target voltage of the first mode may fall within the first voltage range and can be freely set, provided they satisfy the condition defined by equation 7. The third-first voltage V₃₋₁ may increase stepwise from −3 V to −1 V, while mirroring the stepwise increase in the panel driving voltage, while maintaining a voltage difference of 7 V above the panel driving voltage.

For example, when the third AVC circuit 125-3 is driven in the second mode in which adaptive voltage control is not performed, the fifth amplifier 615 according to an example embodiment may apply the third-second voltage based on the second-second target voltage of the second mode and a third-second target voltage to the display panel 130 based on the following equation 8.

$${V}_{3 - 2} = N \times Vtarget {2}_{2} - ( 2 N - 1 ) \times Vtarget {3}_{2} \qquad [ Equation 8 ]$$

V₃₋₂ of equation 8 may represent the third-second voltage applied to the display panel 130 when the third AVC circuit 125-3 is driven in the second mode in which adaptive voltage control is not performed. N may represent the ratio of the panel driving voltage to the first voltage, and Vtarget2₂ and Vtarget3₂ may represent the second-second target voltage of the second mode of the third AVC circuit 125-3 and the third-second target voltage of the second mode of the third AVC circuit 125-3 respectively. ELVSS of equation 8 may represent the panel driving voltage, and Delta may represent the predetermined variation. The second-second target voltage of the second mode may be determined based on a second-second reference voltage of the second mode, a magnitude of the fifth resistor 625, and a magnitude of the sixth resistor 626. The third-second target voltage of the second mode may be determined based on a third-second reference voltage of the second mode, a magnitude of the eleventh resistor 631, and a magnitude of the twelfth resistor 632. The second-second reference voltage of the second mode may be determined based on the second-second target voltage of the second mode included in the third-second voltage applied to the display panel 130 when the third AVC circuit 125-3 does not perform adaptive voltage control.

Similarly to the description above, when describing a specific operation of the third AVC circuit 125-3 operating without adaptive voltage control in the second mode as defined by equation 8, it may be assumed that the third AVC circuit 125-3 operates under conditions where ELVSS, which is the panel driving voltage, is −10 V and a voltage applied to the display panel 130 is −3 V. When the ratio N of the panel driving voltage to the first voltage is 5 and the first voltage is −2 V, the panel driving voltage may increase stepwise from −10 V to −8 V, for example. Since the voltage output circuit 620 consistently applies −3 V as the third-second voltage to the display panel 130 regardless of changes in the panel driving voltage, both of the second-second target voltage of the second mode and the third-second target voltage of the second mode may be set freely within a range that satisfies the condition defined by equation 8.

In other words, the second-first target voltage of the first mode of the third AVC circuit 125-3 that performs adaptive voltage control may be determined based on the second-first reference voltage, the fifth resistor 625, and the sixth resistor 626 provided the condition defined by equation 7 is satisfied. Similarly, the third-first target voltage of the first mode may also be determined based on the third-first reference voltage, the eleventh resistor 631, and the twelfth resistor 632 under the same condition satisfying equation 7. In addition, the second-second target voltage of the second mode of the third AVC circuit 125-3 that does not perform adaptive voltage control may be determined based on the second-second reference voltage, the fifth resistor 625, and the sixth resistor 626 provided the condition defined by equation 8 is satisfied. Similarly, the third-second target voltage of the second mode may also be determined based on the third-second reference voltage, the eleventh resistor 631, and the twelfth resistor 632 under the same condition satisfying equation 8.

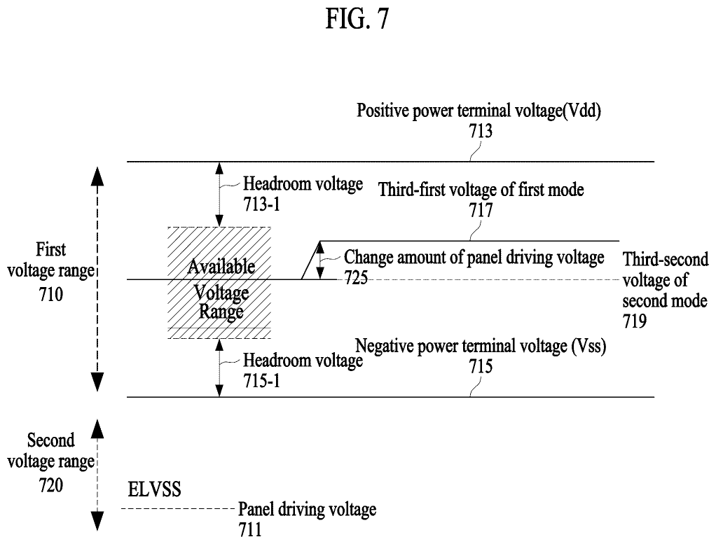

FIG. 7 is a diagram for illustrating a voltage range related to an AVC circuit according to an example embodiment.

Referring to FIG. 7, a first voltage range 710, which is a driving voltage range of an AVC circuit according to an example embodiment, illustrates the magnitude relationship between a panel driving voltage 711 and a third voltage outputted by the AVC circuit. An amplifier included in the AVC circuit according to an example embodiment may operate within the first voltage range 710, which lies between a positive power terminal voltage 713 and a negative power terminal voltage 715. This range ensures proper functioning of the AVC circuit within the first voltage range 710. A voltage range for stably driving the AVC circuit, referred to the (“Available Voltage Range”) extends from a value lower than the positive power terminal voltage 713 by a headroom voltage 713_1 to a value higher than the negative power terminal voltage 715 by a headroom voltage 715_1. Each of the headroom voltage 713-1 and the headroom voltage 715-1 represents a voltage margin for each of the positive power terminal voltage 713 and the negative power terminal voltage 715, respectively. These margins ensure that the amplifier's output signal is not distorted. The values of these headroom voltages are determined by the characteristics of the amplifier, which depend on the amplifier's manufacturing process.

The panel driving voltage 711 according to an example embodiment may be included in a second voltage range 720 that is outside the first voltage range 710. The AVC circuit according to an example embodiment, as described above, may apply a third-first voltage 717 of a first mode to the display panel 130 when the AVC circuit is driven in the first mode to perform adaptive voltage control and may apply a third-second voltage 719 based on a target voltage of a second mode to the display panel 130 when the AVC circuit is driven in the second mode in which adaptive voltage control is not performed. A difference between the third-first voltage 717 and the third-second voltage 719 may be identical to a change amount 725 of the panel driving voltage.

As a more specific example, the operation of the AVC circuit in the first mode for performing adaptive voltage control may be compared to its operation in the second mode. When the AVC circuit according to an example embodiment is driven in the first mode, the panel driving voltage, ELVSS, may be −10 V, which falls within the second voltage range 720. A first voltage generated through voltage division (for example, a 1/5 ratio) of the panel driving voltage may be −2 V, which falls within the first voltage range 710. The voltage applied to the display panel 130 by the AVC circuit may be −3 V. For example, if the panel driving voltage increases stepwise from −10 V to −8 V, the third-first voltage 717 may also increase stepwise from −3 V to −1 V while maintaining the stepwise pattern of the panel driving voltage and preserving a voltage difference of 7 V above the panel driving voltage. When the AVC circuit according to an example embodiment is driven in the second mode, the third-second voltage 719 of the second mode may remain fixed at −3 V, regardless of changes in the panel driving voltage, even if the panel driving voltage increases stepwise from −10 V to −8 V. In sum, since the third-first voltage 717 of the first mode is −1 V and the third-second voltage 719 of the second mode is −3 V, the difference between the two (i.e., subtracting the third-second voltage 719 from the third-first voltage 717) is +2 V. This value matches the change in the panel driving voltage, +2 V. Thus, the AVC circuit according to an example embodiment can determine the change amount 725 of the panel driving voltage by calculating the voltages (e.g., the third-first voltage 717 and the third-second voltage 719) within the first voltage range 710, without directly calculating the panel driving voltage 711 in the second voltage range 720.

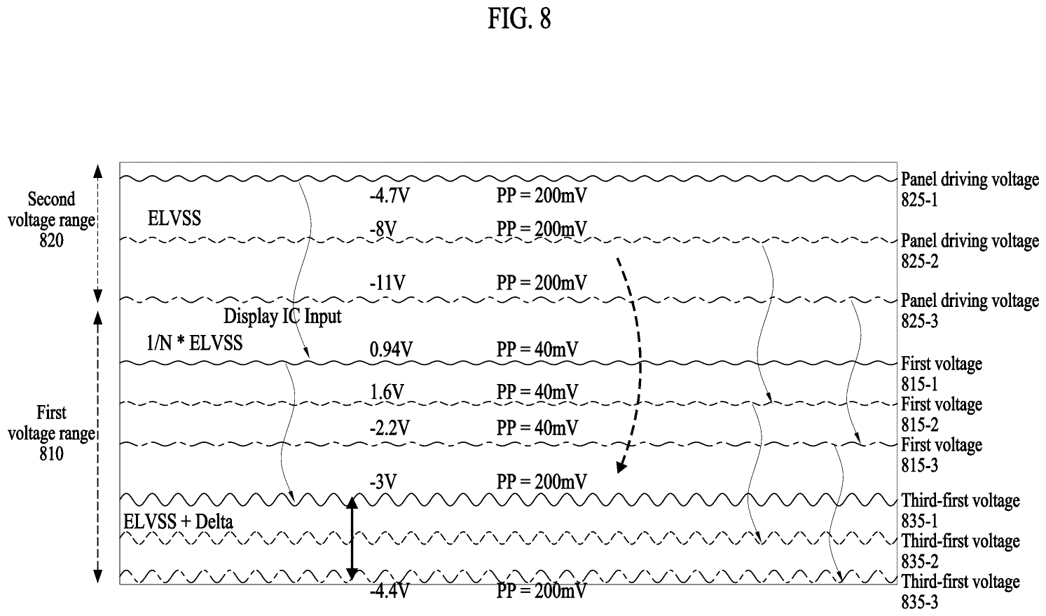

FIG. 8 is a diagram for illustrating a simulation result of an AVC circuit according to an example embodiment.

Referring to FIG. 8, a panel driving voltage 825-1 (for example, −4.7 V) used to drive the display panel 130 according to an example embodiment may be included in a second voltage range 820 that is outside a first voltage range 810 that is a voltage range in which the AVC circuit is driven as described above. A first voltage 815-1 generated through voltage division of the panel driving voltage in the power management integrated circuit 210 according to an example embodiment may be included in the first voltage range 810, and the first voltage 815-1 included in the first voltage range 810 may be applied to a voltage application circuit included in the AVC circuit. When the AVC circuit according to an example embodiment is driven in the first mode to perform adaptive voltage control, a voltage output circuit included in the AVC circuit may generate a third-first voltage 835-1 including the panel driving voltage 825-1 and a predetermined variation based on the first voltage 815-1 and a target voltage and apply the third-first voltage 835-1 to the display panel 130.

Based on FIG. 8, the panel driving voltage 825-1 within the second voltage range 820 may correspond to a sine wave with a peak-to-peak voltage of 200 millivolts (mV) for example. The first voltage 815-1, generated through voltage division (for example, a 1/5 division) of the panel driving voltage 825-1, may correspond to a sine wave with a peak-to-peak voltage of 40 mV, in which lies within the first voltage range 810, i.e., the operating range of the AVC circuit. The AVC circuit according to an example embodiment may generate the third-first voltage 835-1 within the first voltage range 810 through the previously described configuration. This third-first voltage 835-1 may include the panel driving voltage 825-1 from the second voltage range 820, which lies outside the first voltage range 810, and the predetermined variation, as defined by the above equation. As a result, the third-first voltage 835-1 may also correspond to a sine wave with a peak-to-peak voltage of 200 mV, for example. Accordingly, the AVC circuit may apply the third-first voltage 835-1, which includes information about the changing pattern of the panel driving voltage 825-1 but remains within the first voltage range 810 (e.g., the AVC circuit's operating range), to the display panel 130. This is achieved by calculating the first voltage 815-1, which is generated through voltage division of the panel driving voltage 825-1 within the power management integrated circuit 210.

The overall process of generating a third-first voltage applied to the display panel 130 by the AVC circuit according to an example embodiment described above may be similarly applied to various panel driving voltages included in the second voltage range 820. For example, a panel driving voltage 825-2 (for example, −8 V) and a corresponding third-first voltage 835-2, which includes the panel driving voltage 825-2 and a predetermined variation, are generated based on a first voltage 815-2 obtained through voltage division of the panel driving voltage 825-2 and a target voltage. Likewise, a panel driving voltage 825-3 (for example, −11 V) and a corresponding third-first voltage 835-3, which includes the panel driving voltage 825-3 and a predetermined variation, are generated based on a first voltage 815-3 obtained through voltage division of the panel driving voltage 825-3 and a target voltage. Since the process of generating the third-first voltage 835-2 and the third-first voltage 835-3 through the panel driving voltage 825-2 and the panel driving voltage 825-3, respectively, are identical to the process described earlier, further details are omitted to avoid repetition.

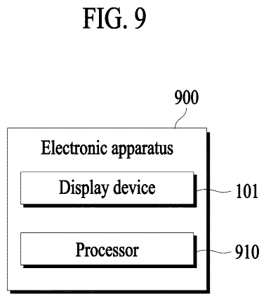

FIG. 9 is a block diagram showing a structure of an electronic apparatus including a display device according to an example embodiment.

Referring to FIG. 9, an electronic apparatus 900 that controls an AVC circuit according to an example embodiment may include the display device 101 and a processor 910. In the electronic apparatus 900 illustrated in FIG. 9, elements related to the example embodiments are illustrated. It will be understood by those of ordinary skill in the art that, in addition to the elements illustrated in FIG. 9, other general-purpose elements may be included. For example, the electronic apparatus 900 according to an example embodiment may include a communication device including one or more transceivers. The communication device may be a device for performing wired and wireless communications and may communicate with an external electronic apparatus. The external electronic apparatus may be a terminal or a server. In addition, a communication technology used by the communication device may include a global system for mobile communication (GSM), code division multi-access (CDMA), long term evolution (LTE), 5G, wireless local area network (WLAN), wireless-fidelity (Wi-Fi), Bluetooth, radio frequency identification (RFID), infrared data association (IrDA), ZigBee, near field communication (NFC), or the like. For example, the electronic apparatus 900 according to an example embodiment may include a memory for storing information to perform operations of a circuit described above through FIGS. 1 to 8. The memory may store one or more instructions executed by the one or more processors 910. The memory may be referred to as storage and may be volatile memory or non-volatile memory. In addition, the memory may store one or more instructions necessary to perform the operation of the processor 910 and may temporarily store data stored on a platform or stored in external memory.

The display device 101 according to an example embodiment may include the power management integrated circuit 210, the display driving circuit 220 including the AVC circuit 125, and the display panel 130 to which a panel driving voltage compensated from the AVC circuit 125 is applied. The AVC circuit may include a voltage application circuit, which applies either a first voltage, generated through voltage division of a panel driving voltage, or a second voltage to a voltage output circuit. The voltage output circuit, in turn, generates a third voltage based on the voltage applied to it and a target voltage, then applies the third voltage to the display panel 130. Hereinafter, descriptions of the display device 101 and related elements that may be included in the electronic apparatus 900, according to an example embodiment, are omitted to avoid duplication of the descriptions provided above.

The processor 910 according to an example embodiment may control the overall operation of the electronic apparatus 900 and process data and signals. The processor 910 may be composed of at least one hardware unit. The processor 910 may correspond to an application processor (AP) that controls the AVC circuit. In addition, the processor 910 may operate by one or more software modules generated by executing one or more program codes stored in the memory. The processor 910 may control the overall operation of the electronic apparatus 900 and process data and signals by executing the program codes stored in the memory.

According to an example embodiment, the processor 910 may be configured to identify a driving mode of the AVC circuit from the display device 101, and when the identified driving mode is a first mode for performing adaptive voltage control, the processor 910 is configured to control the AVC circuit so that the AVC circuit applies a second voltage including a panel driving voltage and a predetermined variation to the display panel 130. The processor 910 according to an example embodiment may obtain information including magnitudes and change amounts of panel driving voltages applied to the display panel 130 by the power management integrated circuit 210 within the display device 101. The processor 910 according to an example embodiment, as described above, may control the operation of the display device 101 by applying a control signal to a multiplexer (for example, the first multiplexer 405 or the second multiplexer 605) included in the AVC circuit 125 included in the display device 101 and determining whether the AVC circuit 125 is driven in the first mode for performing adaptive voltage control. The processor 910 according to an example embodiment, as described above, may also obtain information on various target voltages (for example, a first target voltage, a second target voltage, and a third target voltage) related to the driving of the AVC circuit 125 and control magnitudes of the corresponding target voltages depending on a driving state of the AVC circuit 125.

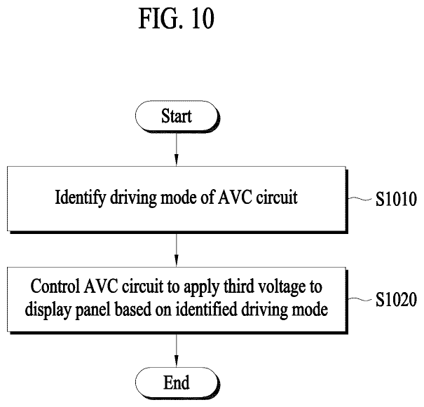

FIG. 10 is a flowchart for illustrating a process of controlling an AVC circuit according to an example embodiment.

Referring to FIG. 10, an electronic apparatus 900 that controls the AVC circuit according to an example embodiment may identify a driving mode of the AVC circuit in operation S1010. The electronic apparatus 900 according to an example embodiment may identify the driving mode of the AVC circuit based on a user input. For example, the user input may include a user input to change an operation state of the electronic apparatus 900 and may include, for example, a user input to increase or decrease the luminance of the display device 101 of the electronic apparatus 900. The electronic apparatus 900 according to an example embodiment may identify a change amount of a panel driving voltage applied to the display panel 130 by the power management integrated circuit 210 of the display device 101. If it is determined that the change amount is greater than or equal to a threshold value, the electronic apparatus 900 may decide to drive the AVC circuit in a first mode to perform adaptive voltage control and then identify the driving mode of the AVC circuit. Similarly, the electronic apparatus 900 may identify a change amount of a panel driving voltage applied to the display panel 130 by the power management integrated circuit 210 of the display device 101. If it is determined that the change amount is less than a threshold value, the electronic apparatus 900 may decide to drive the AVC circuit in a second mode where adaptive voltage control is not performed and then identify the driving mode of the AVC circuit. In addition, the electronic apparatus 900 according to an example embodiment may identify the driving mode of the AVC circuit based on driving mode information of the AVC circuit stored in the memory. This information includes details about the latest driving mode of the AVC circuit.

The electronic apparatus 900 according to an example embodiment may control the AVC circuit so that the AVC circuit applies a third voltage to the display panel based on the identified driving mode in operation S1020. For example, when the identified driving mode is the first mode of the AVC circuit, the electronic apparatus 900 may control the power management integrated circuit so that the first voltage is applied to the voltage output circuit. For example, when a voltage applied to the voltage output circuit is the first voltage, the electronic apparatus 900 may control the voltage output circuit so that a third-first voltage including the panel driving voltage and a predetermined variation is generated. The electronic apparatus 900 may control the AVC circuit so that the AVC circuit applies the third-first voltage including the panel driving voltage and the predetermined variation to the display panel 130. More specifically, the electronic apparatus 900 according to an example embodiment may control the AVC circuit so that the third-first voltage including the panel driving voltage and the predetermined variation is applied to the display panel 130 by applying a control signal to the control signal receiving terminal of the multiplexer (for example, 405 and 605) included in the voltage application circuit (for example, 210, 410, 510, and 610) of the AVC circuit (for example, 125, 125-1, 125-2, and 125-3). For example, the electronic apparatus 900 may control the AVC circuit so that the first multiplexer 405 applies the first voltage to the voltage output circuit 420 by applying a control signal to the control signal receiving terminal of the first multiplexer 405 and, accordingly, may control the AVC circuit so that the voltage output circuit 420 applies the third-first voltage to the display panel 130. For example, the electronic apparatus 900 may control the AVC circuit so that the second multiplexer 605 applies a voltage corresponding to an average value of the first voltage and a second target voltage to the first input terminal 615-1 of the fifth amplifier 615 by applying a control signal to the control signal receiving terminal of the second multiplexer 605 and, accordingly, may control the AVC circuit so that the voltage output circuit 620 applies the third-first voltage to the display panel 130.

For example, when the identified driving mode is the second mode of the AVC circuit, the electronic apparatus 900 may control the power management integrated circuit so that a second voltage is applied to the voltage output circuit. For example, when a voltage applied to the voltage output circuit is the second voltage, the electronic apparatus 900 may control the voltage output circuit so that a third-second voltage based on the second voltage and a target voltage of the second mode is generated.

The electronic apparatus according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as a memory, processing, logic, and/or look-up table, that may execute various functions under the control of one or more microprocessors or other control devices. Similarly to that elements may be implemented as software programming or software elements. In addition, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical configurations. These terms may include the meaning of a series of routines of software in association with a processor or the like.

The above-described example embodiments are merely examples, and other example embodiments may be implemented within the scope of the claims to be described later.

What is claimed is:

1. An adaptive voltage control (AVC) circuit comprising:
a voltage application circuit configured to apply a first voltage or a second voltage to a voltage output circuit, wherein the first voltage is generated by dividing a panel driving voltage; and
the voltage output circuit configured to generate a third voltage based on the first or second voltage and a target voltage, and to apply the third voltage to a display panel.

2. The AVC circuit of claim 1, wherein the voltage application circuit is configured to, apply the first voltage to the voltage output circuit when the AVC circuit operates in a first mode to perform adaptive voltage control and, apply the second voltage to the voltage output circuit when the AVC circuit operates in a second mode in which the adaptive voltage control is not performed, and
wherein the voltage output circuit is configured to generate a third-first voltage, which includes the panel driving voltage and a predetermined variation, when the first voltage is received and, generate a third-second voltage based on the second voltage and a first-second target voltage of the second mode, when the second voltage is received.

3. The AVC circuit of claim 2, wherein the second voltage is a ground voltage.

4. The AVC circuit of claim 1, wherein the voltage output circuit is configured to apply the third voltage to an anode electrode of a light-emitting element included in the display panel, and
wherein the panel driving voltage is applied to a cathode electrode of the light-emitting element.

5. The AVC circuit of claim 1, wherein the first voltage, the second voltage, and the third voltage fall within a first voltage range corresponding to an operating range of the AVC circuit, and
wherein the panel driving voltage falls within a second voltage range that is outside the first voltage range.

6. The AVC circuit of claim 1, wherein the voltage application circuit includes a first multiplexer including a first input terminal to which the first voltage is applied, a second input terminal to which the second voltage is applied, and an output terminal.

7. The AVC circuit of claim 1, wherein the voltage output circuit includes:
a first amplifier including a first input terminal to which the first voltage or the second voltage is applied from the voltage application circuit, a second input terminal, and an output terminal configured to output the third voltage;
a first resistor connected between the output terminal of the first amplifier and the second input terminal of the first amplifier;
a second resistor connected between the first resistor and an output terminal of a second amplifier;
the second amplifier including a first input terminal to which a first reference voltage is applied, a second input terminal, and the output terminal configured to output a first target voltage;
a third resistor connected between the output terminal of the second amplifier and the second input terminal of the second amplifier; and
a fourth resistor connected between the second input terminal of the second amplifier and a ground terminal.

8. The AVC circuit of claim 7, wherein a ratio of the first resistor to the second resistor is based on a ratio of the panel driving voltage to the first voltage.

9. The AVC circuit of claim 7, wherein the first amplifier is configured to apply a third-first voltage, based on the first voltage and a first-first target voltage of a first mode, to the display panel when the AVC circuit operates in the first mode to perform adaptive voltage control and, apply a third-second voltage, based on a first-second target voltage of a second mode, to the display panel when the AVC circuit operates in the second mode in which the adaptive voltage control is not performed, and
wherein a difference between the third-first voltage and the third-second voltage is identical to a change amount of the panel driving voltage.

10. The AVC circuit of claim 7, wherein the first target voltage is based on the first reference voltage, a magnitude of the third resistor, and a magnitude of the fourth resistor.

11. The AVC circuit of claim 1, wherein the voltage application circuit includes:
a third amplifier including a first input terminal to which the first voltage is applied, a second input terminal, and an output terminal;
a fourth amplifier including a first input terminal to which a second reference voltage is applied, a second input terminal, and an output terminal configured to output a second target voltage as the target voltage;
a fifth resistor connected between the output terminal of the fourth amplifier and the second input terminal of the fourth amplifier;
a sixth resistor connected between the second input terminal of the fourth amplifier and a ground terminal;
a seventh resistor connected to the output terminal of the fourth amplifier and the fifth amplifier; and
an eighth resistor connected to the seventh resistor and the output terminal of the third amplifier, and
wherein the second input terminal of the third amplifier and the output terminal of the third amplifier are connected to each other.

12. The AVC circuit of claim 1, wherein the voltage output circuit includes:
a fifth amplifier including a first input terminal to which a voltage corresponding to an average of the first voltage and a second target voltage is applied, a second input terminal, and an output terminal configured to output the second voltage;
a ninth resistor connected between the output terminal of the fifth amplifier and the second input terminal of the fifth amplifier;
a tenth resistor connected between the ninth resistor and an output terminal of a sixth amplifier;
the sixth amplifier including a first input terminal to which a third reference voltage is applied, a second input terminal, and the output terminal configured to output a third target voltage as the target voltage;
an eleventh resistor connected between the output terminal of the sixth amplifier and the second input terminal of the sixth amplifier; and
a twelfth resistor connected between the second input terminal of the sixth amplifier and a ground terminal.

13. The AVC circuit of claim 11, wherein a magnitude of the seventh resistor and a magnitude of the eighth resistor are identical to each other.

14. The AVC circuit of claim 12, wherein the output terminal of the fifth amplifier is configured to output a third-first voltage based on the panel driving voltage, the second target voltage, the third target voltage, and a ratio of the panel driving voltage to the first voltage to the display panel.

15. The AVC circuit of claim 12, wherein the voltage application circuit further includes a second multiplexer including a first input terminal to which the second target voltage is applied from a fourth amplifier, a second input terminal connected between a seventh resistor and an eighth resistor, and an output terminal connected to the first input terminal of the fifth amplifier, and
wherein the second multiplexer is configured to apply a voltage corresponding to an average of the first voltage and a second-first target voltage of a first mode to the first input terminal of the fifth amplifier when AVC circuit operates in the first mode to perform adaptive voltage control and, apply a second-second target voltage of a second mode to the first input terminal of the fifth amplifier when the AVC circuit operates in the second mode in which the adaptive voltage control is not performed.

16. The AVC circuit of claim 15, wherein the fifth amplifier is configured to apply a third-first voltage based on the first voltage, the second-first target voltage of the first mode, and a third-first target voltage of the first mode to the display panel when the AVC circuit operates in the first mode and, apply a third-second voltage based on the second-second target voltage of the second mode and a third-second target voltage of the second mode to the display panel when the AVC circuit operates in the second mode, and
wherein a difference between the third-first voltage and the third-second voltage is identical to a change amount of the panel driving voltage.

17. A control method of an adaptive voltage control (AVC) circuit, the control method comprising:
identifying a driving mode of the AVC circuit; and
controlling the AVC circuit to apply a third voltage to a display panel based on the driving mode,
wherein the AVC circuit includes:
a voltage application circuit configured to apply a first voltage or a second voltage to a voltage output circuit based on the driving mode, wherein the first voltage is generated by dividing a panel driving voltage; and
the voltage output circuit configured to generate the third voltage based on the first or second voltage and a target voltage and to apply the third voltage to the display panel.

18. The control method of claim 17, wherein the voltage application circuit is configured to apply the first voltage to the voltage output circuit when the driving mode is a first mode to perform adaptive voltage control and, apply the second voltage to the voltage output circuit when the driving mode is a second mode in which adaptive voltage control is not performed, and
wherein the voltage output circuit is configured to generate a third-first voltage, which includes the panel driving voltage and a predetermined variation, when the voltage applied to the voltage output circuit is the first voltage and, generate a third-second voltage based on the second voltage and a first-second target voltage of the second mode when the voltage applied to the voltage output circuit is the second voltage.

19. A computer-readable recording medium having a program for executing the control method of claim 18 on a computer.

20. A display device comprising:
a power management integrated circuit (PMIC) configured to generate a panel driving voltage;
a display driving circuit including an adaptive voltage control (AVC) circuit; and
a display panel,
wherein the AVC circuit includes:
a voltage application circuit configured to apply a first voltage or a second voltage to a voltage output circuit, wherein the first voltage is generated by dividing the panel driving voltage; and
the voltage output circuit configured to generate a third voltage based on the first or second voltage and a target voltage and to apply the third voltage to the display panel.
